(19) United States
(12) Patent Application Publication
(10) Pub. No.: US 2025/0323718 A1
(43) Pub. Date: Oct. 16, 2025

(54) INFORMATION PROCESSING METHOD, COMMUNICATION DEVICE, AND STORAGE MEDIUM

(71) Applicant: Beijing Xiaomi Mobile Software Co., Ltd., Beijing (CN)

(72) Inventor: Yuxin MAO, Beijing (CN)

(73) Assignee: Beijing Xiaomi Mobile Software Co., Ltd., Beijing (CN)

(21) Appl. No.: 18/864,838

(22) PCT Filed: May 12, 2022
(86) PCT No.: PCT/CN2022/092541

§ 371 Date: Nov. 11, 2024

(51) Int. Cl. H04B 7/185; H04B 7/19; H04B 7/195; H04W 8/22; H04W 60/04

(52) U.S. Cl. CPC H04B 7/18541; H04B 7/18547; H04B 7/19; H04B 7/195; H04W 8/22; H04W 60/04

(57) ABSTRACT

Embodiments of the present disclosure provide an information processing method and apparatus, a communication device, and a storage medium. The information processing method executed by a first network element may comprise: in response to determining, on the basis of ephemeris information, that a user equipment (UE) is to move out of the coverage range of a first access network, determining that the UE is handed over from the first access network to a second access network for access; wherein the first access network is a satellite access network; and sending a UE route selection policy (URSP) to the UE, wherein the USRP instructs the UE to preferentially perform communication on the basis of the second access network.

### CROSS-REFERENCE TO RELATED APPLICATIONS

The present disclosure is a U.S. national phase of PCT Application No. PCT/CN2022/092541 filed on May 12, 2022, the content of which is hereby incorporated by reference in its entirety.

### TECHNICAL FIELD

The present disclosure relates to, but is not limited to, a field of wireless communication technology, and in particular, to information processing methods, communication devices, and storage mediums.

### BACKGROUND

A 5-th generation mobile communication (5G) core network supports a user terminal to access a network through a satellite.

If satellite access is used to provide a network service for user equipment (UE), the satellite access may be affected by insufficient number of satellites in a satellite chain, discontinuous satellite beams, etc., which may result in discontinuous coverage provided to a ground. That is, when a user accesses a network through a satellite in a certain region, there is no satellite signal coverage in a specific time period.

Therefore, in a process of the UE accessing a network and deploying services, it is to consider the discontinuous coverage for the satellite access. For example, when there is no signal coverage, the UE is in a sleep or power saving state, to save power consumption of the terminal; and when the satellite signal coverage is restored, the UE is woken up in time to reconnect with the network or deploy the services.

For another example, if the network side is to send downlink signaling or downlink data to the UE, the network side is to determine whether the UE is currently in the satellite signal coverage.

If the UE is in the satellite signal coverage, the network side sends the signaling/data to the UE.

If the UE is not in the satellite signal coverage, the network side is to buffer the signaling/data, and when determining that the satellite signal coverage for the UE is restored, the network side sends the signaling/data to the UE.

In conclusion, in the case where the UE accesses the network through the satellite and there is the discontinuous coverage for the satellite access, when generating the signaling/data, both the UE and the network side are to determine whether the UE is in the satellite signal coverage in combination with a satellite coverage condition, and perform communication interaction only when the UE is in the satellite signal coverage.

In the scheme, in the case where the UE is not in the satellite signal coverage, the UE keeps the idle state, so that when the satellite signal coverage for the UE is restored, the UE may immediately switch from the idle state to a connected state and deploy rapidly the services; and the purpose of saving the power consumption of the terminal in the period of no signal coverage is achieved.

### SUMMARY

Embodiments of the present disclosure provide information processing methods, communication devices, and storage mediums.

A first aspect of the embodiments of the present disclosure provides an information processing method. The method is performed by a first network element and includes: determining, in response to determining that user equipment (UE) is to move out of a coverage range of a first access network based on ephemeris information, that the UE switches from accessing the first access network to accessing a second access network, where the first access network is a satellite access network; and sending the user equipment route selection policy (URSP) to the UE, where the USRP instructs the UE to preferentially communicate based on the second access network.

A second aspect of the embodiments of the present disclosure provides an information processing method. The method is performed by UE and includes: receiving a user equipment route selection policy (URSP), where the USRP instructs the UE to preferentially communicate based on a second access network; and communicating through the second access network according to the URSP, where the second access network is a network accessed by the UE before the UE moves out of a coverage range of a first access network, where the first access network is a satellite access network.

A third aspect of the embodiments of the present disclosure provides a communication device, including a processor, a transceiver, a memory, and an executable program stored in the memory and capable of being executed by the processor, where the processor, when executing the executable program, performs the information processing method provided in the first aspect or in the second aspect.

A fourth aspect of the embodiments of the present disclosure provides a computer storage medium storing an executable program, where the executable program is executed by a processor, the information processing method provided in the first aspect or in the second aspect can be implemented.

It should be understood that the general description and the detailed description in the following text are only exemplary and explanatory, and cannot limit the embodiments of the present disclosure.

### BRIEF DESCRIPTION OF DRAWINGS

The accompanying drawings here are incorporated into the specification and form a part of this specification, show embodiments conforming to the present disclosure and are used together with the specification to explain principles of embodiments of the present disclosure.

FIG. 1 is a schematic structural diagram of a wireless communication system shown according to an exemplary embodiment.

FIG. 2 is a schematic flowchart of an information processing method shown according to an exemplary embodiment.

FIG. 3 is a schematic flowchart of an information processing method shown according to an exemplary embodiment.

FIG. 4 is a schematic flowchart of an information processing method shown according to an exemplary embodiment.

FIG. 5 is a schematic flowchart of an information processing method shown according to an exemplary embodiment.

FIG. 6 is a schematic flowchart of an information processing method shown according to an exemplary embodiment.

FIG. 7 is a schematic flowchart of an information processing method shown according to an exemplary embodiment.

FIG. 8 is a schematic flowchart of an information processing method shown according to an exemplary embodiment.

FIG. 9 is a schematic structural diagram of an information processing apparatus shown according to an exemplary embodiment.

FIG. 10 is a schematic structural diagram of an information processing apparatus shown according to an exemplary embodiment.

FIG. 11 is a schematic structural diagram of UE shown according to an exemplary embodiment.

FIG. 12 is a schematic structural diagram of a communication device shown according to an exemplary embodiment.

### DETAILED DESCRIPTION

Exemplary embodiments will be described in details herein, with examples thereof represented in the accompanying drawings. When the following description involves the accompanying drawings, same numerals in different figures represent same or similar elements unless otherwise indicated. Implementations described in the following exemplary embodiments do not represent all implementations consistent with embodiments of the present disclosure. Rather, they are only examples of apparatuses and methods that are consistent with some aspects of embodiments of the present disclosure.

Terms used in the embodiments of the present disclosure are only for a purpose of describing specific embodiments, and are not intended to limit the embodiments of the present disclosure. Singular forms, “a/an,” “the,” and “this,” used in the present disclosure are also intended to include majority forms, unless the context clearly indicates other meanings. It should also be understood that the term “and/or” used herein refers to and includes any or all possible combinations of one or more related listed items.

It should be understood that although terms, such as “first,” “second,” “third,” etc., may be used in the embodiments of the present disclosure to describe various information, such information should not be limited by these terms. These terms are only used to distinguish same type of information from each other. For example, without departing from the scope of the embodiments of the present disclosure, first information may also be referred to as second information, and similarly, the second information may also be referred to as the first information. Depending on the context, the term “if” used herein may be interpreted as “when,” “while,” or “in response to determining.”

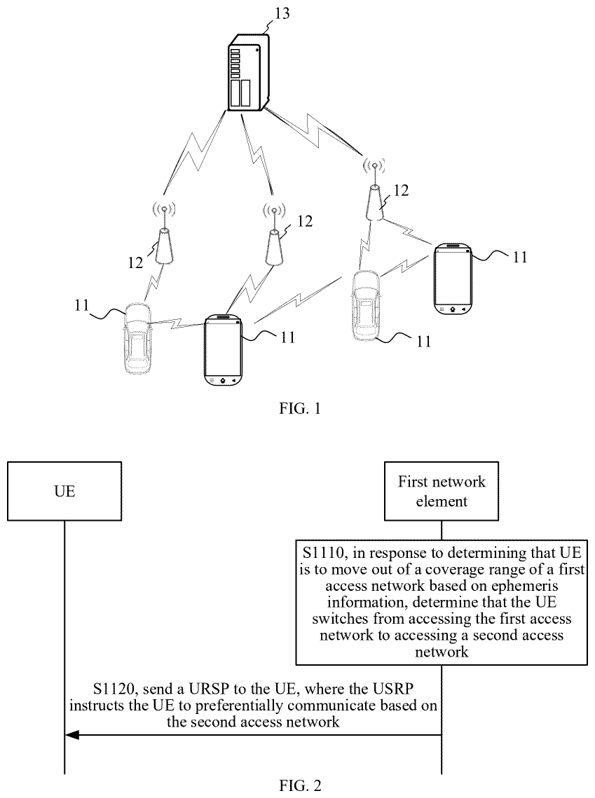

Referring to FIG. 1, FIG. 1 shows a schematic structural diagram of a wireless communication system provided by an embodiment of the present disclosure. As shown in FIG. 1, the wireless communication system is a cellular mobile communication technology-based communication system, and the wireless communication system may include several UE 11 and several access devices 12.

The UE 11 may be a device that provides voice and/or data connectivity to a user. The UE 11 may communicate with one or more core networks through a radio access network (RAN). The UE 11 may be Internet of Things UE, such as a sensor device, a mobile phone (or referred to as a “cellular” phone), and a computer having the Internet of Things UE, for example a fixed, portable, pocket, handheld, computer built-in, or vehicle-mounted apparatus. For example, the UE may be a station (STA), a subscriber unit, a subscriber station, a mobile station, a mobile table, a remote station, an access point, remote UE (or remote terminal), access UE (or access terminal), a user terminal, a user agent, or a user device. Alternatively, the UE 11 may be a device of an unmanned aerial vehicle. Alternatively, the UE 11 may be a vehicle-mounted device, for example, a vehicle computer having a wireless communication function, or a wireless communication device externally connected to a vehicle computer. Alternatively, the UE 11 may also be a roadside device, for example, a street lamp, a signal light, other roadside device, etc., having a wireless communication function.

The access device 12 may be a network side device in the wireless communication system. The wireless communication system may be a 4-th generation mobile communication (4G) system, also referred to as a long term evolution (LTE) system; or the wireless communication system may also be a 5G system, also referred to as a new radio (NR, or new air interface) system or a 5G NR system. Alternatively, the wireless communication system may be a next generation system of the 5G system. The access network in the 5G system may be referred to as an NG-RAN (new generation-radio access network). Alternatively, the wireless communication system may be an MTC (manual toll collection) system.

The access device 12 may be an evolved access device (eNB) used in the 4G system. Alternatively, the access device 12 may also be an access device using a centralized distributed architecture access device (gNB) in the 5G system. When the access device 12 uses the centralized distributed architecture, the access device 120 usually includes a central unit (CU) and at least two distributed units (DUs). The central unit is provided with a protocol stack of a packet data convergence protocol (PDCP) layer, a radio link control (RLC) layer, and a media access control (MAC) layer; and the distributed unit is provided with a protocol stack of a physical (PHY) layer. The specific implementation of the access device 12 is not limited in the embodiment of the present disclosure.

A wireless connection may be established between the access device 12 and the UE 11 through a wireless air interface. In different implementations, the wireless air interface is a wireless air interface based on a 4-th generation mobile communication network technology (4G) standard; or the wireless air interface is a wireless air interface based on a 5-th generation mobile communication network technology (5G) standard, for example, the wireless air interface is a new radio; or the wireless air interface may also be a wireless air interface based on a next generation mobile communication network technology standard of the 5G.

In some embodiments, as shown in FIG. 1, the wireless communication system may also include a network management device 13. The several access devices 12 are respectively connected to the network management device 13.

As shown in FIG. 2, an embodiment of the present disclosure provides an information processing method. The method is performed by a first network element and includes the following steps S1110-S1120.

At step S1110, in response to determining that UE is to move out of a coverage range of a first access network based on ephemeris information, it is determined that the UE switches from accessing the first access network to accessing a second access network, where the first access network is a satellite access network.

At step S1120, a user equipment route selection policy (URSP) is sent to the UE, where the USRP instructs the UE to preferentially communicate based on the second access network.

The first network element may include a core network element for managing the network access and/or mobility of the UE, and the core network element may be further referred to as a core network device. For example, the first network element may be an AMF (access and mobility management function) network element or an MME (mobility management entity) network element. Alternatively, the first network element may be a policy control function (PCF) network element. For example, it is set that the first network element is a PCF network element, when the PCF network element determines that the UE is to leave the coverage range of the first access network, the PCF network element determines a second access network accessible by the UE, enables the UE to access the second access network, and updates the URSP of the UE, where the updated URSP may be used for the UE to preferentially communicate through the second access network.

The first access network is a network that the UE is currently accessing.

The first access network is an NTN (non-terrestrial network) access network. The NTN may also be referred to as a satellite access network. For example, when the satellite access network uses a non-synchronous satellite, the satellite moves relative to the ground, and at this time, a moving rate of the UE may be negligible relative to a moving rate of the satellite. In a discontinuous coverage scenario, the UE will leave the network coverage of the first access network. If the UE leaves the network coverage of the first access network, the UE cannot continue to communicate through the first access network.

In the discontinuous coverage scenario, the number of satellites in the satellite chain may be insufficient, resulting in that a certain region on the ground cannot be continuously covered by the satellite access network. The network coverage provided in the embodiments of the present disclosure may be understood as network signal coverage. For example, the network signal coverage is coverage of satellite signals transmitted by a satellite or coverage of base station signals transmitted by a base station.

The coverage range of the first access network may be a coverage range of network signals of the first access network.

According to the technical solution provided in the embodiment of the present disclosure, when determining that the UE is to move out of the coverage range of the first access network based on the ephemeris information, and determining that the UE is to switch from accessing the first access network to accessing the second access network, the URSP enabling the UE to select to communicate through the second access network is sent to the UE, so that the communication interruption phenomenon caused by the UE leaving the coverage range of the first access network is reduced, and the communication continuity of the UE is ensured.

In some embodiments, the step S1110 may include: before the UE leaves the coverage range of the first access network, determining that the UE switches from accessing the first access network to accessing the second access network.

In the embodiment of the present disclosure, to solve a communication interruption state caused by the UE losing the network coverage in the discontinuous coverage scenario, before the UE leaves the coverage range of the first access network, the UE may switch to accessing the second access network, so that after the UE loses the network coverage of the first access network, the UE may continue to obtain the network coverage of the second access network and communicate through the second access network.

If the access of the UE is to switch from accessing the first access network to accessing the second access network, the first network element re-sends a URSP to the UE, where the URSP is for the UE preferentially selecting the second access network to receive and send data when the UE performs data interaction with a network device, so as to switch the access network for transmitting the service data of the UE.

The ephemeris information may include ephemeris information of a plurality of satellite access networks. The plurality of satellite access networks may include at least the first access network. For example, the ephemeris information may be used to determine a satellite motion trajectory.

The second access network is different from the first access network.

For example, the first access network is an NTN access network, and the second access network is a TN (terrestrial network) access network. Alternatively, the first access network may be an NTN access network, and the second access network may be an NTN access network of another access type different from the first access network.

In some embodiments, the second access network and the first access network may belong to access networks provided by different communication operators; or in other embodiments, the second access network and the first access network may belong to access networks provided by a same operator and using different access technologies. If the second access network and the first access network belong to different communication operators, the access technology used by the second access network may be same as or different from the access technology used by the first access network.

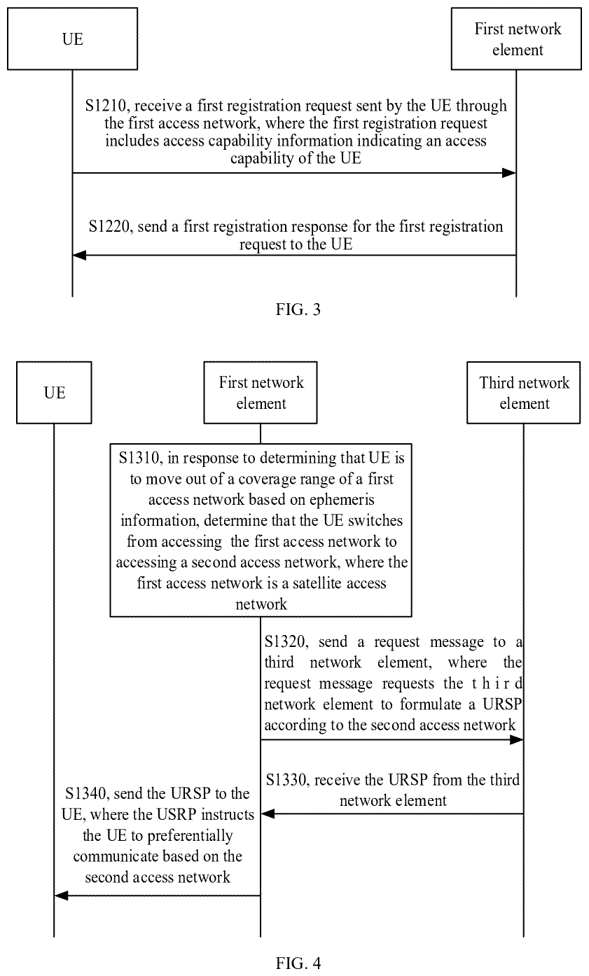

As shown in FIG. 3, an embodiment of the present disclosure provides an information processing method. The method is performed by a first network element and includes the following steps S1210-S1220.

At step S1210, a first registration request sent by the UE through the first access network is received, where the first registration request includes access capability information indicating an access capability of the UE.

At step S1220, a first registration response for the first registration request of the UE is sent.

The information processing method may be performed separately, or may be implemented in combination with any of the embodiments.

In some embodiments, the first registration request includes access capability information of the UE, where the access capability information may indicate that the UE is capable of selecting and accessing different types of access networks.

In some embodiments, if the UE currently accesses the first access network, the first registration response may include a first registration acceptance message.

The UE completes access of the UE to the first access network with the first registration request and the first registration response.

In the embodiment of the present disclosure, the first registration request includes access capability information indicating an access capability of the UE, where the access capability information may be used for the first network element to determine a second access network accessible by the UE before the UE leaves the first access network.

In some embodiments, the access capability information indicates that the UE supports at least one of: an access manner based on low earth orbit (LEO) satellite access; an access manner based on medium earth orbit (MEO) satellite access; an access manner based on geosynchronous earth orbit (GEO) satellite access; an access manner based on new radio (NR) access; or an access manner based on LTE access.

For example, if the first access network and the second access network are different satellite access networks, the second access network and the first access network may be access networks that belong to different communication operators and use a same access technology. For example, the second access network and the first access network may be LEO networks and/or MEO networks belonging to different communication operators. The LEO network is an access network that provides access through the LEO. The MEO network may be an access network that provides access through the MEO.

For example, if the first access network and the second access network are different satellite networks, the second access network may be a GEO network, where the GEO network may be an access network that provides access through the GEO.

The access manner based on the NR access may be for the UE to access the NR network, and the access manner based on the LTE access may be for the UE to access the LET network. Both the NR network and the LET network are TNs.

The UE accesses the network each time, the UE reports an access technology supported by the UE with a registration request, so that if the UE accesses a satellite access network with discontinuous coverage, according to a plurality of access technologies supported by the UE, a second access network supported by the UE and accessible by the UE may be found, before the UE moves out of the coverage of the currently accessed first access network. After receiving the first registration request, the first access network extracts the access capability information and stores the access capability information, or stores the access capability information of the UE to the second network element. The second network element may also be a core network element (i.e. core network device), for example, the second network element may be a dedicated data storage network element in core network elements.

In an embodiment, the method further includes: storing an access type of the first access network in a correspondence with a network element identifier of the first network element in a second network element.

In the embodiment of the present disclosure, upon receiving the first registration request, the first access network allows the UE to access the first access network, and accordingly sends the access type of the first access network and the network element identifier of the first network element to the second network element with a registration message. Such that, after the second network element receives them, the second network element stores the access type of the first access network in a correspondence with the network element identifier of the first network element.

For example, the second network element includes but is not limited to a unified data management (UDM) network element or a home subscriber server (HSS).

In some embodiments, determining, in response to determining that the UE is to move out of the coverage range of the first access network based on the ephemeris information, that the UE switches from accessing the first access network to accessing the second access network, includes: determining the second access network according to at least one of: the access capability information of the UE; location information of the UE; network information of an access network subscribed by the UE; or ephemeris information of a satellite access network subscribed by the UE.

The access capability information of the UE may be reported to the first network element with the first registration request, or the first network element may also receive, from the second network element, the access capability information of the UE that is pre-stored in the second network element.

In an embodiment, determining the second access network according to at least one of the following information includes: determining the second access network according to access capability information of the UE and the location information of the UE.

In an embodiment, determining the second access network according to at least one of the following information includes: determining the second access network according to access capability information of the UE, the location information of the UE, and at least one of: network information of an access network subscribed by the UE; or ephemeris information of a satellite access network subscribed by the UE. The location information of the UE may be reported by the UE with any one non-access stratum (NAS) message. The location information of the UE includes, but is not limited to, longitude and latitude information. In summary, the location information of the UE includes, but is not limited to, any information representing a location of the UE, such as latitude and longitude of the UE, etc. The location information of the UE may include location information reported by the UE.

The access network subscribed by the UE includes, but is not limited to, a satellite access network and/or a TN access network.

In some embodiments, the location information of the UE may be trusted location information reported by the UE and passing network verification. There are various manners to perform the network verification for the location information of UE, which will not be described one by one here.

The access network subscribed by the UE may depend on a subscription protocol between the UE and the communication operator. The network information of the access network subscribed by the UE may include at least a network identifier of the access network subscribed by the UE. For example, the access network subscribed by the UE includes a satellite access network.

For example, the first network element may determine, according to access capability information of the UE, an access technology that can be used by the UE, access the access technology supported by the UE and the access network subscribed by the UE, and select a second access network that is accessible by the UE and subscribed by the UE before the UE leaves the first access network.

As shown in FIG. 4, an embodiment of the present disclosure provides an information processing method. The method is performed by a first network element and includes the following steps S1310-S1340.

At step S1310, in response to determining that UE is to move out of a coverage range of a first access network based on ephemeris information, it is determined that the UE switches from accessing the first access network to accessing a second access network, where the first access network is a satellite access network.

At step S1320, a request message is sent to a third network element, where the request message requests the third network element to formulate the URSP according to the second access network.

At step S1330, the URSP is received from the third network element.

At step S1340, the URSP is sent to the UE, where the USRP instructs the UE to preferentially communicate based on the second access network.

The third network element may also be a core network element, and the core network element includes but is not limited to a policy control function (PCF) network element.

In the embodiment of the present disclosure, when the first network element determines that the access of the UE switches from accessing the first access network to accessing the second access network, the first network element may request, from the third network element, the URSP for the UE to preferentially transmit service data from the second access network.

After receiving the request message, the third network element returns the URSP to the first network element, such that after the first network element receives the URSP from the third network element, the first network element may send the URSP to the access network element (i.e. access device) for the UE, and the access device forwards the URSP to the UE.

In some embodiments, sending the URSP to the UE further includes: sending the URSP before the UE moves out of the coverage range of the first access network.

If the URSP is sent to the UE before the UE moves out of the coverage range of the first access network, the UE directly preferentially communicates through the second access network according to the URSP after the UE accesses the access network. The communication includes, but is not limited to, service data communication and/or signaling communication.

In some embodiments, if the UE accesses the second access network before the UE moves out of the coverage range of the first access network, there may be a case that the UE accesses both the first access network and the second access network, and in this case, if the UE receives a URSP for preferentially communicating through the second access network, the UE preferentially communicates through the second access network.

For example, before moving out of the coverage range of the first access network, the UE sends the URSP to the UE through the first access network.

In some embodiments, the method further includes: receiving a second registration request sent by the UE through the second access network, where the second registration request is a registration request sent by the UE through the second access network according to the URSP; and sending a second registration response to the UE.

If the URSP is sent to the UE before the UE moves out of the coverage range of the first access network, and the URSP instructs the UE to preferentially communicate through the second access network, the UE sends the second registration request to the network under triggering of the URSP. The second registration request is a registration request that the UE requests to register with the second access network, and the second registration request may be sent according to the URSP provided by the first network element.

After the first network element receives the second registration request, the first network element may agree to the registration request for the UE to register with (that is, access) the second access network. Therefore, the second registration response sent to the UE through the access device may be a second registration acceptance message.

In some embodiments, the method further includes: storing an access type of the second access network in a correspondence with a network element identifier of the first network element in a second network element.

In some embodiments, upon determining that the UE accesses the second access network, the first network element sends the access type of the UE accessing the second access network and the network element identifier of the first network element to the second network element. Accordingly, when the second network element receives them, the second network element stores the access type of the second access network in a correspondence with the network element identifier of the first network element in the second network element.

The second network element includes but is not limited to a UDM network element and/or an HSS.

In some embodiments, the method further includes: sending a switching instruction before the UE moves out of the coverage range of the first access network, where the switching instruction is to trigger the UE to switch to accessing the second access network.

In the embodiment of the present disclosure, if the first network element determines that the UE is to switch to accessing the second access network, the first network element may send the switching instruction to the access device of the first access network, so that the UE receives an access instruction forwarded by the access device of the first access network, and before the UE moves out of the coverage range of the first access network, the UE receives the switching instruction for triggering the UE to switch the access network, and switches to accessing the second access network.

In this case, the URSP may be sent to the UE through the second access network, after the UE switches to accessing the second access network.

For example, after the UE receives the switching instruction, the UE sends a registration request for requesting to access the second access network, and receives a second registration acceptance response returned by the first network element, to complete registration of the UE with the second access network.

For example, sending the URSP to the UE includes: sending the URSP to the UE after the UE accesses the second access network.

For example, after the UE accesses the second access network, the URSP is sent to the UE, so that the UE preferentially communicates through the second access network according to the URSP returned by the second access network, where the communication includes but is not limited to: service data communication and/or signaling communication.

In some embodiments, the method further includes:
performing, after the UE accesses the second access network, deregistration on the UE accessing through the first access network; or changing a state of the UE accessing the first access network to an idle state.

In an embodiment, after the UE accesses the second access network, the UE may actively initiate a deregistration procedure, so that the UE deregisters from the first access network. Therefore, the UE may directly communicate based on the second access network. For example, the UE sends a deregistration request to the first network element, so that the first network element performs deregistration of the UE from the first access network after the first network element receives the deregistration request.

In another embodiment, after the UE accesses the second access network, a radio resource control (RRC) state of the UE through the first access network may be changed to an RRC idle state, so that the network device on the network side will consider that the UE is unreachable through the first access network, and therefore communicates with the UE through the second access network.

As shown in FIG. 5, an embodiment of the present disclosure provides an information processing method. The method is performed by UE and includes the following steps S2110-S2120.

At step S2110, a URSP is received, where the USRP instructs the UE to preferentially communicate based on a second access network.

At step S2120, the UE communicates through the second access network according to the URSP, where the second access network is a network accessed by the UE before the UE moves out of a coverage range of a first access network, where the first access network is a satellite access network.

The UE may be various types of terminals. The UE receives the URSP from the network device, for example, receiving the URSP forwarded by the access device and provided by the first network element.

After receiving the URSP and after accessing the second access network, the UE communicates with a network device and/or an opposite end device through the second access network.

In some embodiments, receiving the URSP includes: receiving, before the UE moves out of the coverage range of the first access network, the URSP through the first access network.

The USRP is received by the UE through the first access network before the UE leaves the network coverage of the first access network, or may be received by the UE through the second access network after the UE switches from accessing the first access network to accessing the second access network.

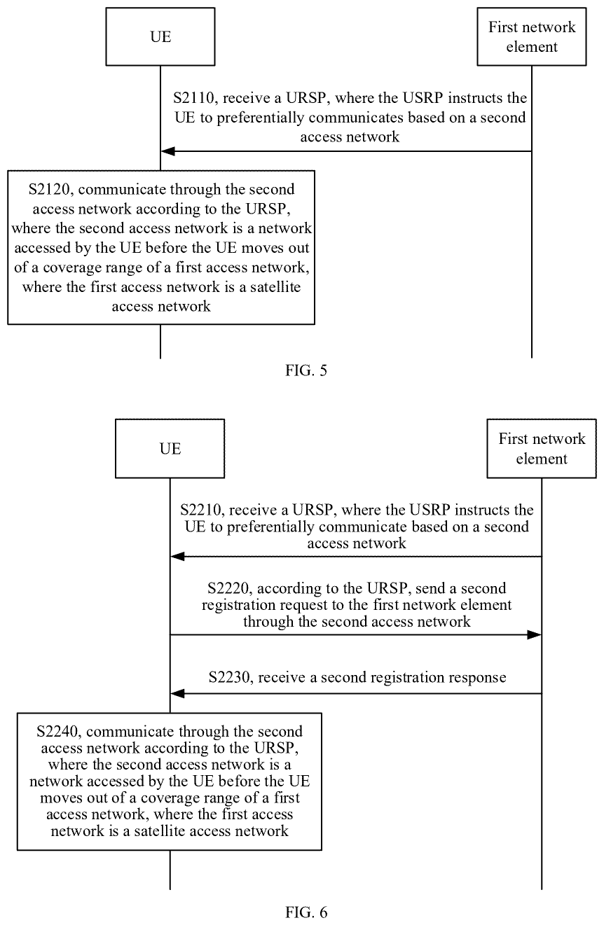

As shown in FIG. 6, an embodiment of the present disclosure provides an information processing method. The method is performed by UE and includes the following steps S2210-S2240.

At step S2210, a URSP is received, where the USRP instructs the UE to preferentially communicate based on a second access network.

At step S2220, according to the URSP, a second registration request is sent to the first network element through the second access network.

At step S2230, a second registration response is received.

At step S2240, the UE communicates through the second access network according to the URSP, where the second access network is a network accessed by the UE before the UE moves out of a coverage range of a first access network, where the first access network is a satellite access network.

For example, after the UE receives the URSP through the first access network, the UE sends the second registration request through the second access network according to the URSP, and in this case, the first network element allows the UE to access the second access network. Therefore, the second registration response may be a second acceptance response.

After the UE successfully accesses the second access network, the UE may communicate through the second access network.

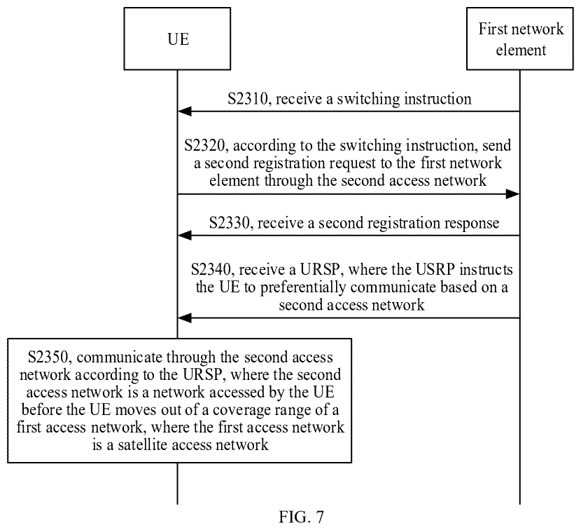

As shown in FIG. 7, an embodiment of the present disclosure provides an information processing method. The method is performed by UE and includes the following steps S2310-S2350.

At step S2310, a switching instruction is received.

At step S2320, according to the switching instruction, a second registration request is sent to the first network element through the second access network.

At step S2330, a second registration response is received.

At step S2340, a URSP is received, where the USRP instructs the UE to preferentially communicate based on a second access network.

At step S2350, the UE communicates through the second access network according to the URSP, where the second access network is a network accessed by the UE before the UE moves out of a coverage range of a first access network, where the first access network is a satellite access network.

In some embodiments, before the UE receives the URSP, the UE first receives a switching instruction, where the switching instruction may instruct the UE to access an access network. The switching instruction may include a network identifier of the second access network, an identifier of the access network element and/or a radio parameter for accessing the second access network.

After the UE receives the switching instruction, the UE sends the second registration request according to the switching instruction, and receives the second registration response returned by the core network device (that is, the first network element), to implement access of the UE with the second access network.

In some other embodiments, before the UE receives the URSP, the UE first receives a switching instruction, where the switching instruction may instruct the UE to access an access network. The switching instruction may include a network identifier of the second access network, an identifier of the access network element and/or a radio parameter for accessing the second access network. The radio parameter includes but is not limited to a resource parameter of a time-frequency resource used by the UE to access the second access network.

Certainly, this is merely an exemplary explanation of the UE accessing the second access network, and specific implementation thereof is not limited to the examples.

In some embodiments, receiving the URSP includes: receiving the URSP through the second access network.

In the embodiment of the present disclosure, after the UE accesses the second access network, the UE may receive the URSP through the second access network.

In some embodiments, the method further includes: initiating, after the UE accesses the second access network, deregistration on the UE accessing through the first access network; or changing, after the UE moves out of the coverage range of the first access network, a state of the UE accessing the first access network to an idle state.

In the embodiment of the present disclosure, after the UE accesses the second access network, the UE initiates deregistration on the UE accessing through the first access network, so that the UE performs the deregistration from the first access network.

After the UE moves out of the coverage range of the first access network, the UE changes a state of the UE in the first access network to the idle state. For example, because the UE cannot continue to monitor the network signal of the first access network after the UE leaves the coverage range of the first access network, the UE initiates a registration request for the first access network, and if the UE does not successfully register within a timing range of a registration update timer, the UE automatically switches to be the idle state.

In some embodiments, before receiving the URSP, the method includes: sending a first registration request through the first access network, where the first registration request includes access capability information of the UE.

When the UE accesses the first access network, the UE provides the first network element with the access capability information of the UE, so that the first network element determines, according to the access capability supported by the UE, a second access network accessible by the UE before the UE moves out of the first access network, thereby implementing continuous coverage of the network for the UE.

In some embodiments, the access capability information indicates that the UE supports at least one of: an access manner based on LEO satellite access; an access manner based on MEO satellite access; an access manner based on GEO satellite access; an access manner based on NR access; or an access manner based on LTE access.

An embodiment of the present disclosure provides another solution for solving a problem of discontinuous coverage of a satellite. During the UE loses the signal coverage of the currently accessed satellite, the UE continues to use network services by accessing another available access network. On the one hand, this may shorten the time when the UE cannot use the network services due to the discontinuous coverage of the currently accessed satellite, and on the other hand, this may also help maintain the continuity of the UE deploying services.

For example, the UE is deploying services by LEO access, and due to movement of the satellite, when the coverage of the LEO for the region where the UE is located is to be lost, the UE may quickly switch the services to MEO access, so that when the LEO does not provide the coverage for the region where the UE is located, the UE may continue to deploy the services by the MEO.

It is set that the UE supports simultaneous a plurality of access technologies, and may simultaneously use different access technologies to access the network.

An embodiment of the present disclosure further provides an information processing METHOD. The method may include following steps.

The first network element determines, according to the ephemeris information, that the first satellite access network is to no longer provide coverage for the region where the UE is located, and selects a second satellite access network accessible by the UE.

The third network element updates the URSP according to the second satellite access network access, and provides the URSP to the first network element.

The first network element provides the UE with the URSP. The URSP defines that the UE deploys services through the second satellite access network.

The UE accesses the second satellite access network according to the URSP, to complete access registration.

The UE completes service migration from the first satellite access network to the second satellite access network according to the URSP.

Before the second access network is determined, when the UE performs registration through the first satellite access network, the registration request carries access capability information that the UE supports access to access technologies.

In a process of the UE performing the access registration, the UDM network element stores association relationship information between the access type (RAT-TYPE) and the selected AMF.

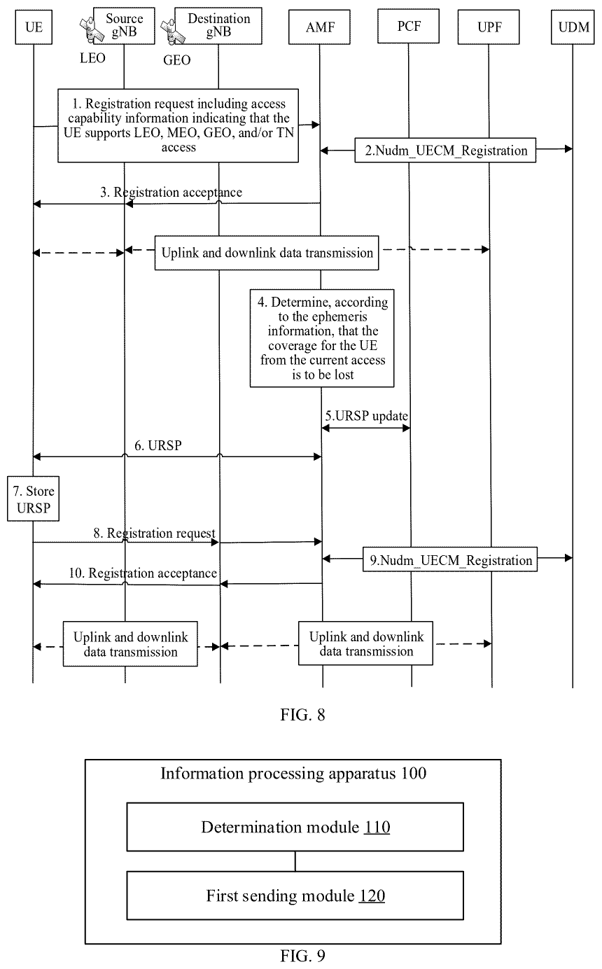

As shown in FIG. 8, an embodiment of the present disclosure provides an information processing method. The method may include the following steps.
1. The UE accesses the 5G core network by an LEO, initiates an initial registration request, where the initial registration request carries access capability information that the UE supports access to a plurality of access technologies, for example, the access capability information also indicates whether the UE supports LEO access, MEO access, GEO access, terrestrial NR access and/or LTE access, and the like.
2. The AMF network element processes a registration process of the UE, and initiates a registration request (Nudm_UECM_Registration) to the UDM network element; the UDM network element stores current access used by the UE, for example, RAT-TYPE=association between “LEO” and the selected AMF identifier.
3. The AMF network element returns the registration acceptance to the UE, to complete the initial registration process of the UE.

In this case, the UE accesses the network by the LEO, and interacts a service data flow with a user plane function (UPF) network element through a source next generation base station (gNB).
4. The AMF network element determines, according to the ephemeris information and in combination with the current location of the UE, that the signal coverage of the LEO for the region where the location of the UE is located is to be lost, and in combination with the capability that the UE supports the plurality of access technologies in the step 1, the AMF network element determines to use other available access (for example, MEO) for the UE to access when the region where the UE is located loses the coverage of the LEO.

That is, when the UE loses the coverage of the LEO, the MEO may provide coverage for a region where the UE is located. The AMF network element determines that the coverage of the LEO for the region where the UE is located is lost, and a precondition that the MEO may provide coverage for the region where the UE is located is that the AMF network element may obtain ephemeris information of a plurality of satellite access systems.
5. The AMF network element requests the PCF network element to update the URSP, and requests to update the URSP for the UE deploying services through the LEO to the URSP for the UE deploying services through the MEO. The PCF network element sends the updated URSP to the AMF network element.

This process of the AMF network element determining, in combination with the ephemeris information, that the LEO cannot provide the coverage for the UE, and selecting the MEO to provide the coverage for the UE, may be performed by the PCF network element.
6. The AMF network element sends the updated URSP to the UE through a user configuration update (UCU) procedure. The USRP defines that the UE deploys services through the MEO access.
7. The UE stores the updated URSP.
8. When the UE migrates the service data flow from the LEO to the MEO according to the updated URSP, if the UE has not registered the network through the MEO at this time, the UE initiates a registration process for accessing the MEO at this time. In the registration process, the same AMF network element is selected according to a 5G globally unique temporary UE identifier (GUTI). That is, the AMF network element is the AMF network element selected when the UE accesses through the LEO. The 5G-GUTI is information generated when the UE accesses through the LEO, and is sent to the UE for storage.
9. The AMF network element processes a registration process of the UE, and initiates Nudm_UECM_Registration to the UDM network element; the UDM network element stores current access used by the UE, that is, RAT-TYPE=association between “MEO” and the selected AMF identifier.
10. The AMF network element returns a registration acceptance message, and the UE completes a registration process through the MEO access.

In this case, according to the updated URSP, the UE interacts the service data flow through the MEO access.

Since the service data is migrated to the MEO based on the URSP, at this time, the UE may actively initiate a deregistration process through the LEO access, or the UE enters a LEO coverage loss period, the UE is to enter an idle state through the LEO access according to the related technologies, and sets an implicit deregistration timer according to the related technologies, and when the timer expires, the UE automatically enters a deregistration state through the LEO access.

As shown in FIG. 9, an embodiment of the present disclosure provides an information processing apparatus 100. The apparatus 100 includes: a determination module 110 and a first sending module 120.

The determination module 110 is configured to determine, in response to determining that user equipment (UE) is to move out of a coverage range of a first access network based on ephemeris information, that the UE switches from accessing the first access network to accessing a second access network, where the first access network is a satellite access network.

The first sending module 120 is configured to send a user equipment route selection policy (URSP) to the UE, where the USRP instructs the UE to preferentially communicate based on the second access network.

The information processing apparatus 100 may be included in a first network element (not shown).

In some embodiments, the determination module 110 and the first sending module 120 may be program modules, and after the program modules are executed by a processor, the operations can be implemented.

In some embodiments, the determination module 110 and the first sending module 120 may be software and hardware combination modules, and the software and hardware combination modules may include editable arrays. The editable arrays include but are not limited to field programmable arrays and/or complex programmable arrays.

In some other embodiments, the determination module 110 and the first sending module 120 may be hardware-only modules; and the hardware-only modules are not limited to application specific integrated circuits.

In some embodiments, the apparatus 100 further includes a first receiving module (not shown). The first receiving module is configured to receive, before determining, in response to determining that the UE is to move out of the coverage range of the first access network based on the ephemeris information, that the UE switches from accessing the first access network to accessing the second access network, a first registration request sent by the UE through the first access network, where the first registration request includes access capability information indicating an access capability of the UE. Where the first sending module 120 is further configured to send a first registration response for the first registration request of the UE.

In some embodiments, the access capability information indicates that the UE supports at least one of: an access manner based on LEO satellite access; an access manner based on MEO satellite access; an access manner based on GEO satellite access; an access manner based on NR access; or an access manner based on LTE access.

In some embodiments, the apparatus 100 further includes: a first storage module (not shown), configured to store an access type of the first access network in a correspondence with a network element identifier of the first network element in a second network element.

In some embodiments, the determination module 110 is configured to determine the second access network according to at least one of: the access capability information of the UE; location information of the UE; network information of an access network subscribed by the UE; or ephemeris information of a satellite access network subscribed by the UE.

For example, the determination module 110 is configured to determine the second access network according to access capability information of the UE and the location information of the UE.

For another example, the determination module 110 is further configured to determine the second access network according to access capability information of the UE, the location information of the UE, and at least one of: network information of an access network subscribed by the UE; or ephemeris information of a satellite access network subscribed by the UE.

In some embodiments, the first sending module 120 is further configured to send, before sending the URSP, a request message to a third network element, where the request message is for the third network element to formulate the URSP according to the second access network. Where the apparatus 100 further includes a second receiving module (not shown), configured to receive the URSP from the third network element.

In some embodiments, the first sending module 120 is configured to send the URSP before the UE moves out of the coverage range of the first access network.

In some embodiments, the apparatus 100 further includes a third receiving module (not shown), further configured to receive a second registration request sent by the UE through the second access network, where the second registration request is a registration request sent by the UE through the second access network according to the URSP. The first sending module 120 is further configured to send a second registration response to the UE.

In some embodiments, the apparatus 100 further includes: a second storage module (not shown), configured to store an access type of the second access network in a correspondence with a network element identifier of the first network element in a second network element.

In some embodiments, the first sending module 120 is further configured to send a switching instruction before the UE moves out of the coverage range of the first access network, where the switching instruction is to trigger the UE to switch to accessing the second access network.

In some embodiments, the first sending module 120 is further configured to send the URSP to the UE after the UE accesses the second access network.

In some embodiments, the apparatus 100 further includes a first execution module (not shown), configured to: perform, after the UE accesses the second access network, deregistration on the UE accessing through the first access network; or change, after the UE moves out of the coverage range of the first access network, a state of the UE accessing the first access network to an idle state.

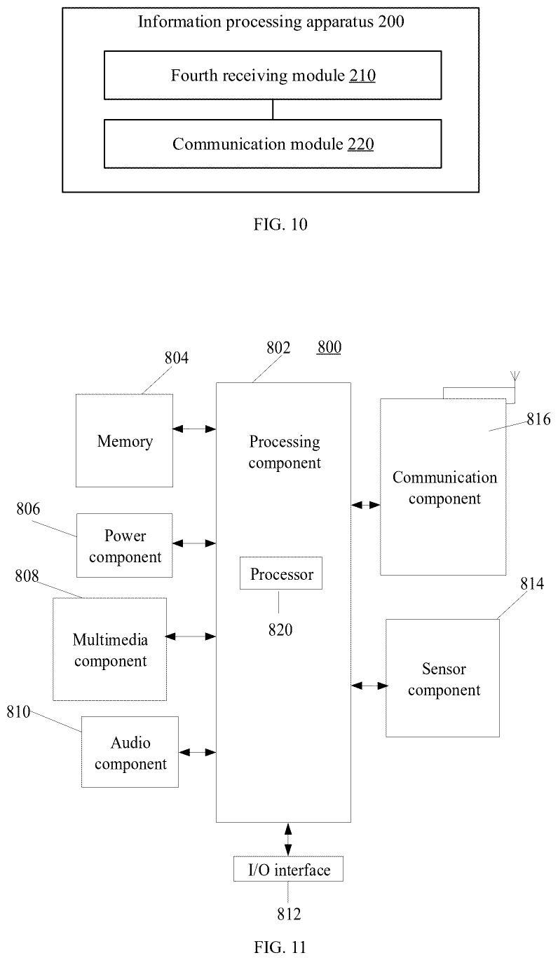

As shown in FIG. 10, an embodiment of the present disclosure provides an information processing apparatus 200. The apparatus 200 further includes: a fourth receiving module 210 and a communication module 220.

The fourth receiving module 210 is configured to receive a user equipment route selection policy (URSP), where the USRP instructs the UE to preferentially communicate based on a second access network.

The communication module 220 is configured to communicate through the second access network according to the URSP, where the second access network is a network accessed by the UE before the UE moves out of a coverage range of a first access network, where the first access network is a satellite access network.

The information processing apparatus 200 may be included in the UE.

In some embodiments, the fourth receiving module 210 and the communication module 220 may be program modules, and after the program modules are executed by the processor, the operations can be implemented.

In some embodiments, the fourth receiving module 210 and the communication module 220 may be software and hardware combination modules, and the software and hardware combination modules may include editable arrays. The editable arrays include but are not limited to field programmable arrays and/or complex programmable arrays.

In some other embodiments, the fourth receiving module 210 and the communication module 220 may be hardware-only modules; and the hardware-only modules are not limited to application specific integrated circuits.

In some embodiments, the fourth receiving module 210 is configured to receive, before the UE moves out of the coverage range of the first access network, the URSP through the first access network.

In some embodiments, the apparatus 200 further includes a second sending module (not shown), configured to send, according to the URSP, a second registration request to a first network element through the second access network. Where the fourth receiving module 210 is configured to receive a second registration response.

In some embodiments, the fourth receiving module 210 is further configured to receive a switching instruction before receiving the URSP. Where the apparatus 200 further includes: a third sending module (not shown), configured to send, according to the switching instruction, a second registration request to a first network element through the second access network; and where the fourth receiving module 210 is further configured to receive a second registration response.

In some embodiments, the fourth receiving module 210 is further configured to receive the URSP through the second access network.

In some embodiments, the apparatus 200 further includes a second execution module (not shown), configured to: initiate, after the UE accesses the second access network, deregistration on the UE accessing through the first access network; or change a state of the UE accessing the first access network to an idle state.

In some embodiments, the apparatus 200 includes: the fourth receiving module 210, further configured to send, before receiving the URSP, a first registration request through the first access network, where the first registration request includes access capability information of the UE.

In some embodiments, the access capability information indicates that the UE supports at least one of: an access manner based on LEO satellite access; an access manner based on MEO satellite access; an access manner based on GEO satellite access; an access manner based on NR access; or an access manner based on LTE access.

An embodiment of the present disclosure provides a communication device, including: a memory configured to store instructions executable by the processor; and a processor connected to the memory. Where the processor is configured to perform the information processing method provided in any of the technical solutions.

The processor may include various types of storage mediums. The storage mediums are non-transitory computer-readable storage mediums, and can continue to memorize information stored in the storage mediums after the communication device is powered off.

Herein, the communication device includes UE or a network element, and the network element may be any one of the first network element to third network element.

The processor may be connected to the memory by a bus or the like, and is configured to read an executable program stored in the memory, to implement for example, at least one of the methods shown in FIGS. 2 to 8.

FIG. 11 is a block diagram of UE 800 shown according to an exemplary embodiment. For example, the UE 800 may be a mobile phone, a computer, a digital broadcast user equipment, a message transceiving device, a game console, a tablet device, a medical device, a fitness device, a personal digital assistant, etc.

Referring to FIG. 11, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the UE 800, such as operations associated with display, phone calls, communication, camera operations, and recording operations. The processing component 802 may include one or more processors 820 to execute instructions to generate all or part of the steps in any of the methods. Additionally, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to storing various types of data to support operations of the UE 800. Examples of such data include instructions, contact data, phonebook data, messages, pictures, videos, etc., for any application program or method operating on the UE 800. The memory 804 may be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

The power component 806 provides power to various components of the UE 800. The power component 806 may include a power supply management system, one or more power supplies, and other components that are associated with generating, managing, and distributing power for the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen, to receive an input signal from the user. The touch panel includes one or more touch sensors to sense the touch, the slide, and the gesture on the touch panel. The touch sensor may not only sense a boundary of the touch or slide action, but also detect a duration and pressure related to the touch or slide operation. In some embodiments, the multimedia component 808 includes a front facing camera and/or a rear facing camera. When the UE 800 is in an operation mode, such as a shooting mode or a video mode, the front facing camera and/or the rear facing camera may receive external multimedia data. Each of the front facing camera and rear facing camera may be a fixed optical lens system or has a focal length and an optical zoom capability.

The audio component 810 is configured to output and/or input audio signals. For example, the audio component 810 includes a microphone (MIC). The microphone is configured to receive external audio signals when the UE 800 is in the operating mode, such as a call mode, a recording mode, and a speech recognition mode. The received audio signals may be further stored in the memory 804 or sent via the communication component 816. In some embodiments, the audio component 810 also includes a speaker for outputting the audio signals.

The I/O interface 812 provides an interface between the processing component 802 and peripheral interface modules. The peripheral interface modules may be keyboards, click wheels, buttons, etc. These buttons may include but are not limited to: a home button, a volume button, a start button, and a lock button.

The sensor component 814 includes one or more sensors to provide various aspects of state assessment for the UE 800. For example, the sensor component 814 may detect an open/closed state of the UE 800, relative positioning of components that are for example a display and keypad of the UE 800. The sensor component 814 may also detect a position change of the UE 800 or of a component of the UE 800, presence or absence of the user contacting with the UE 800, an orientation or acceleration/deceleration of the UE 800, and a temperature change of the UE 800. The sensor component 814 may include a proximity sensor configured to detect the presence of nearby objects without any physical contact. The sensor component 814 may also include a light sensor, such as a CMOS or CCD image sensor, for use in an imaging application. In some embodiments, the sensor component 814 may also include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 2G, 3G, or a combination of them. In an exemplary embodiment, the communication component 816 receives, via a broadcast channel, a broadcast signal or broadcast related information from an external broadcast management system. In an exemplary embodiment, the communication component 816 further includes a near-field communication (NFC) module to facilitate short-range communication. For example, the NFC module may be implemented based on a radio frequency identification (RFID) technology, an infrared data association (IrDA) technology, an ultra-wideband (UWB) technology, a Bluetooth (BT) technology, and other technologies.

In an exemplary embodiment, the UE 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform any of the methods.

In an exemplary embodiment, a non-transitory computer-readable storage medium including instructions is also provided, such as the memory 804 including the instructions. The instructions may be executed by the processor 820 of the UE 800 to generate any of the methods. For example, the non-transitory computer-readable storage medium may be a ROM, a random access memory (RAM), a CD-ROM, a magnetic tape, a floppy disk, an optical data storage device, etc.

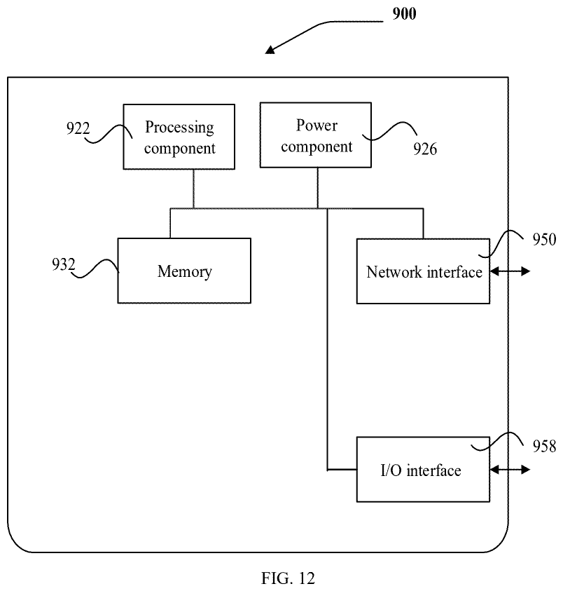

As shown in FIG. 12, an embodiment of the present disclosure shows a structure of a communication device. For example, the communication device 900 may be provided as a network side device. The communication device may be various network elements, such as the access network element and/or the network function network elements, etc.

Referring to FIG. 12, the communication device 900 includes a processing component 922 that further includes one or more processors (not shown), and memory resources represented by a memory 932, for storing instructions that is executable by the processing component 922, such as an application program. The application program stored in the memory 932 may include one or more modules that each corresponds to a set of instructions. In addition, the processing component 922 is configured to execute instructions to perform any method applied to the communication device in the methods, for example, the method shown in any one of FIGS. 2 to 8.

The communication device 900 may also include a power component 926 configured to perform power management of the communication device 900, a wired or wireless network interface 950 configured to connect the communication device 900 to the network, and an input/output (I/O) interface 958. The communication device 900 may operate an operating system stored in the memory 932, such as Windows Server TM, Mac OS X™, Unix™, Linux™, FreeBSD™, or a similar operating system.

Those skilled in the art will easily come up with other implementation solutions of embodiments of the present disclosure after considering the specification and practicing the present disclosure disclosed herein. The present disclosure aims to cover any variations, uses, or adaptive changes of embodiments of the present disclosure, which follow general principles of the embodiments of the present disclosure and include common knowledge or customary technical means in the art not disclosed in the present disclosure. The specification and embodiments are only considered exemplary, and the true scope and spirit of embodiments of the present disclosure are indicated by the following claims.

It should be understood that embodiments of the present disclosure are not limited to the precise structure described and shown in the accompanying drawings, and various modifications and changes may be made without departing from their scope. The scope of embodiments of the present disclosure is limited only by the appended claims.

A fifth aspect of the embodiments of the present disclosure provides an information processing apparatus. The apparatus includes: a determination module, configured to determine, in response to determining that user equipment (UE) is to move out of a coverage range of a first access network based on ephemeris information, that the UE switches from accessing the first access network to accessing a second access network, where the first access network is a satellite access network; and a first sending module, configured to send a URSP to the UE, where the USRP instructs the UE to preferentially communicate based on the second access network.

A sixth aspect of the embodiments of the present disclosure provides an information processing apparatus. The apparatus includes: a fourth receiving module, configured to receive a user equipment route selection policy (URSP), where the USRP instructs the UE to preferentially communicate based on a second access network; and a communication module, configured to communicate through the second access network according to the URSP, where the second access network is a network accessed by the UE before the UE moves out of a coverage range of a first access network, where the first access network is a satellite access network.

1. An information processing method, performed by a first network element and comprising:
determining, in response to determining that user equipment (UE) is to move out of a coverage range of a first access network based on ephemeris information, that the UE switches from accessing the first access network to accessing a second access network, wherein the first access network is a satellite access network; and
sending a user equipment route selection policy (URSP) to the UE, wherein the USRP instructs the UE to preferentially communicate based on the second access network.

2. The method of claim 1, wherein before determining that the UE switches from accessing the first access network to accessing the second access network, the method further comprises:
receiving a first registration request sent by the UE through the first access network, wherein the first registration request comprises access capability information indicating an access capability of the UE; and
sending a first registration response for the first registration request of the UE.

3. The method of claim 2, wherein the access capability information indicates that the UE supports at least one of:
an access manner based on low earth orbit (LEO) satellite access,
an access manner based on medium earth orbit (MEO) satellite access,
an access manner based on geosynchronous earth orbit (GEO) satellite access,
an access manner based on new radio (NR) access, or
an access manner based on long term evolution (LTE) access.

4. The method of claim 2, further comprising:
storing an access type of the first access network in a correspondence with a network element identifier of the first network element in a second network element.

5. The method of claim 1, wherein determining that the UE switches from accessing the first access network to accessing a second access network, comprises:
determining the second access network according to access capability information of the UE and location information of the UE; or
determining the second access network according to access capability information of the UE, location information of the UE, and at least one of:
network information of an access network subscribed by the UE, or
ephemeris information of a satellite access network subscribed by the UE.

6. The method of claim 1, wherein before sending the URSP to the UE, the method further comprises:
sending a request message to a third network element, wherein the request message requests the third network element to formulate the URSP according to the second access network; and
receiving the URSP from the third network element.

7. The method of claim 1, wherein the sending the URSP to the UE, comprises:
sending, before the UE moves out of the coverage range of the first access network, a switching instruction to trigger the UE to switch to accessing the second access network; and
sending, after the UE accesses the second access network, the URSP to the UE.

8. The method of claim 7, further comprising:
receiving a second registration request sent by the UE through the second access network, wherein the second registration request is a registration request sent by the UE through the second access network according to the URSP; and
sending a second registration response to the UE.

9. The method of claim 8, further comprising:
storing an access type of the second access network in a correspondence with a network element identifier of the first network element in a second network element.

10-11. (canceled)

12. The method of claim 8, further comprising:
performing, after the UE accesses the second access network, deregistration on the UE accessing through the first access network; or
changing, after the UE moves out of the coverage range of the first access network, a state of the UE accessing the first access network to an idle state.

13. An information processing method, performed by user equipment (UE) and comprising:
receiving a user equipment route selection policy (URSP), wherein the USRP instructs the UE to preferentially communicate based on a second access network; and
communicating through the second access network according to the URSP, wherein the second access network is a network accessed by the UE before the UE moves out of a coverage range of a first access network, wherein the first access network is a satellite access network.

14. The method of claim 13, wherein receiving the URSP, comprises:
receiving, before the UE moves out of the coverage range of the first access network, the URSP through the first access network.

15. The method of claim 14, wherein communicating through the second access network according to the URSP, comprises:
sending, according to the URSP, a second registration request to a first network element through the second access network;
accessing the second access network, in response to receiving a second registration response for the second registration request; and
communicating through the second access network.

16. (canceled)

17. The method of claim 13, wherein receiving the URSP, comprises:
receiving a switching instruction;
sending, according to the switching instruction, a second registration request to a first network element through the second access network;
accessing the second access network, in response to receiving a second registration response for the second registration request; and
receiving the URSP through the second access network.

18. The method of claim 17, further comprising:
initiating, after the UE accesses the second access network, deregistration on the UE accessing through the first access network; or
changing, after the UE accesses the second access network, a state of the UE accessing the first access network to an idle state.

19. The method of claim 13, wherein before receiving the URSP, the method further comprises:
sending a first registration request through the first access network, wherein the first registration request comprises access capability information of the UE, and
wherein the access capability information indicates that the UE supports at least one of:
an access manner based on low earth orbit (LEO) satellite access;
an access manner based on medium earth orbit (MEO) satellite access;
an access manner based on geosynchronous earth orbit (GEO) satellite access;
an access manner based on new radio (NR) access; or
an access manner based on long term evolution (LTE) access.

20-28. (canceled)

29. A communication device, comprising a processor, a transceiver, a memory, and an executable program stored in the memory and capable of being executed by the processor, wherein the processor executes the executable program to:
determine, in response to determining that user equipment (UE) is to move out of a coverage range of a first access network based on ephemeris information, that the UE switches from accessing the first access network to accessing a second access network, wherein the first access network is a satellite access network; and
send a user equipment route selection policy (URSP) to the UE, wherein the USRP instructs the UE to preferentially communicate based on the second access network.

30. A non-transitory computer-readable storage medium storing an executable program, wherein a processor executes the executable program to implement the method of claim 1.

31. A communication device, comprising a processor, a transceiver, a memory, and an executable program stored in the memory and capable of being executed by the processor, wherein the processor executes the executable program to implement the method of claim 13.

32. A non-transitory computer storage medium storing an executable program, wherein a processor executes the executable program to implement the method of claim 13.
